(19) United States
(12) Patent Application Publication
(10) Pub. No.: US 2001/0030249 A1
(43) Pub. Date: Oct. 18, 2001

(54) Fuel injectors

(76) Inventors: Kenzo Nagasaka, Obu (JP); Kazuaki Koyanagi, Obu (JP); Yukinori Kato, Obu (JP)

Correspondence Address: Dennison, Scheiner, Schultz & Wakeman, Suite 612, 1745 Jefferson Davis Highway, Arlington, VA, 22202, US

(21) Appl. No.: 09/782,059

(22) Filed: Feb. 14, 2001

(30) Foreign Application Priority Data
Feb. 24, 2000 (JP) 2000-47089

(51) Int. Cl. F02M 51/00

(52) U.S. Cl. 239/585.1; 239/900

(57) ABSTRACT

A fuel injector (20) may have an approximately cylindrical body (30) and a valve (40) adapted to reciprocate within a body (30). A valve seat (50) may have an opening (56) and may be positioned downstream of valve (40) such that opening (56) becomes closed when valve (40) moves downstream and opening (56) becomes open when valve (40) moves upstream. An orifice plate (60) may be coupled to the downstream side of valve seat (50). Valve seat (50) may press fit into the interior of body (30) and at least a portion of the outer surface of valve seat (50) preferably frictionally contacts the interior surface of body (30). One or more protrusions (32) may be formed on the interior surface of body (30). At least one protrusion (32) may optionally contact orifice plate (60). Further, the portion of the outer surface of valve seat (50) that is closest to valve seat opening (56) preferably does not frictionally contact the interior surface of body (30). Moreover, body (30) may have a relatively thin wall portion (34) that frictional contacts valve seat (50).

### BACKGROUND OF THE INVENTION

1. Technical Field

The present invention relates to improved fuel injectors, which may be preferably utilized with internal combustion engines for vehicles.

2. Description of the Related Art

U.S. Pat. No. 5,263,648 discloses a known electromagnetic fuel injector having a generally cylindrical body, a valve that reciprocates inside the body, a valve seat having an opening and disposed within the body and an orifice plate having holes that permits fuel to be exhausted through holes in the orifice plate. The orifice plate is welded to the valve seat and the orifice plate is laser welded to the interior surface of the body. Further, the valve seat is positioned within the body such that the opening is closed when the valve moves forward and the opening is open when the valve moves rearward.

In this electromagnetic fuel injector, the valve repeatedly collides with the valve seat during use. If the impact force of the collision displaces the valve seat toward the downstream tip of the body, the volume of fuel injected per unit time when the valve is open will deviate from the desired or ideal amount. Therefore, it is necessary to securely fasten the valve seat to the body in order to prevent the valve seat from being displaced toward the downstream tip of the body. The valve seat of the '648 patent is not directly fastened to the body and the valve seat does not frictionally contact the body. Instead, only the orifice plate is fastened to the body by a weld. Thus, a strong weld is required between the orifice plate and the body in order to prevent the valve seat/orifice plate from being displaced downstream when the valve repeatedly collides with the valve seat during operation.

Because the orifice plate of the '648 patent is welded to the body, the fuel injection volume per unit time before and after the welding step are not equal because the welding step affects the fuel injection volume per unit time due to thermal effects. In other words, according to the '648 patent, the positional relationship between the body and the valve seat is first adjusted in order to obtain the desired or ideal fuel injection volume per unit time and then the body is laser welded to the orifice plate. The laser welding step will likely change the position of the valve seat/orifice plate within the body, due to the metal contracting after cooling, and thereby change the fuel injection volume per unit time. As a result, the '648 patent teaches that it is necessary to again adjust the fuel injection volume per unit time after the welding step. Thus, assembly of the fuel injector of the '648 patent is time consuming and labor intensive, because the fuel injection volume per unit time must be adjusted at least twice in order to obtain the desired output value.

Further, in order to re-adjust the fuel injection volume per unit time to the desired or ideal value after the welding step, the orifice plate of the '648 patent must be plastically deformed (i.e. stretched) after the orifice plate has been welded to the body until the desired or ideal value is again obtained. However, if the fuel injection volume per unit time is adjusted by plastically deforming (e.g. stretching) the orifice plate, “spring-back” will occur in the plastically deformed orifice plate. That is, the valve seat/orifice plate will not maintain the preferred position within the body, because the orifice plate will contract after being stretched and thereby change the fuel injection volume per unit time. Therefore, in order to obtain the desired or ideal fuel injection volume per unit time, the process of plastically deforming the orifice plate typically must be repeated. Thus, it is sometimes necessary to adjust the fuel output rate three or more times using this technique in order to obtain the desired fuel output rate.

Japanese Laid-open Patent Publication No. 63-186960 describes a structure in which a valve seat having a cylindrical external shape is press-fitted into an approximately cylindrical body, thereby fixing the relative positional relationship between the body and the valve seat. As explained above, because the valve repeatedly collides with the valve seat during the use of the electromagnetic fuel injector, the valve seat is subjected to a force that displaces the valve seat toward the tip of the body. To prevent the valve seat from being displaced toward the tip of the body during operation, the valve seat must tightly fit (i.e. frictionally fit) within the body. However, in order to achieve such a tight fit, a large press-fitting force must be applied to the valve seat in order to insert the valve seat into the body.

If the valve seat is press fit into the body using a force large enough to prevent the valve seat from being displaced relative to the body when valve repeatedly collides with the valve seat during operation, the press fitting force may actually be so excessive that the valve seat, and the shape of the seal surface, is deformed during the press fitting step. As a result, the valve seat opening changes from its original shape, thereby adversely affecting the seal between the seal surface of the valve seat and the valve surface. Consequently, fuel may leak through the fuel injector when the valve is in the closed position. Thus, defective fuel injections may be readily formed using this technique.

U.S. Pat. No. 5,713,523 discloses a valve seat having a cylindrical external shape that is press fit into a generally cylindrical body. The valve reciprocation distance (i.e., the valve stroke or the oppositional distance between the valve seat and the valve when the valve is open, which distance in part determines the fuel injection volume per unit time when the valve is opened) is first tuned by adjusting the positional relationship between the body and the valve seat along the axial direction. Thereafter, the body and the press-fit valve seat are fastened by laser welding. However, welding partially melts the metal body and metal valve seat. When these parts cool, the metal will contract and cause the valve stroke distance to change. Therefore, after the laser welding step, it is typically necessary to re-tune the valve stroke of the fuel injector of the '523 patent. Thus, this technique suffers the same disadvantages as the '648 patent.

### SUMMARY OF THE INVENTION

It is, accordingly, an object of the present invention to teach improved fuel injectors.

In one aspect of the present teachings, fuel injectors are taught that are capable of reliably maintaining the positional relationship between the body and the valve seat in the axial direction for a long period of time.

In another aspect of the present teachings, it is only necessary to adjust the fuel injection volume per unit time one time during the assembly process of a fuel injector. Further, techniques for securing the valve seat to the body are taught that do not change the fuel output rate after it has been set.

In another aspect of the present teachings, relatively low tolerance parts may be utilized to construct the fuel injector, because the process of adjusting the fuel injection volume per unit time can accurately and reliably set the desired fuel output rate.

In another aspect of the present teachings, fuel injectors can be manufactured using a lower press-fitting force than known fuel injectors, even though the valve seat is retained within the body by frictional contact between the two parts. Thus, it is possible to eliminate or significantly reduce deformation of the seal surface, which may degrade the sealing performance when the valve is in the closed position.

In another aspect of the present teachings, the process of press-fitting the valve seat within the body can be performed substantially simultaneously with the process of tuning (adjusting) the fuel injection volume per unit time to the desired fuel output rate. When the desired fuel injection volume per unit time is reached, the press fitting operation is stopped. The positional relationship between the valve, the valve seat and the body which have been tuned in this way, may be reliably maintained for a long period of time due to the tight fit (frictional fit) between the valve seat/orifice plate and the fuel injector body. Therefore, fuel injectors manufactured using this technique do not require a subsequent re-tuning process in order to achieve the desired or ideal fuel injection volume per unit time.

In another aspect of the present teachings, the fuel injector may have a valve seat that is press fit into the body and the interior surface of the body may include a protrusion that prevents the valve seat from axially sliding downstream relative to the body. That is, the protrusion is disposed within the interior surface of the body and downstream of the valve seat. Thus, a lower press-fitting force can be utilized to manufacture a fuel injector while still securely and reliably positioning the valve seat within the fuel injector body using frictional contact. Further, this technique does not require the valve seat (or orifice plate) to be welded to the body. As a result, it is not necessary to re-adjust the fuel injection volume per unit time after the valve seat has been press-fit and appropriately positioned within the body.

In another aspect of the present teachings, the fuel injector body may have a thin wall portion (i.e. a portion of the body that is thinner than other portions of the body). This thin wall portion preferably corresponds to the position of a portion of the valve seat that frictionally contacts the inner surface of the body in order to fix the position of the valve seat/orifice plate within the body. The diameter of the valve seat may be slightly larger than the diameter of a portion of the interior of the body before the valve seat is press-fit into the body. When the valve seat is press-fit into the body, the position of the valve seat within the body is fixed by the frictional fit of the valve seat and the body.

By reducing the thickness of the body along the portion of the body that will frictionally contact the valve seat, the pressure exerted on the valve seat by the body is less than the pressure exerted onto the valve seat if the thickness of the body is not reduced. Because the pressure exerted by the body onto the valve seat is reduced, it is possible to reduce or eliminate deformation of the valve seat, and thus the valve seat opening, during the press-fitting step. Therefore, the integrity of the valve seat and the valve seat opening can be maintained, even though the position of the valve seat within the body is at least partially secured by a frictional fit between the outer surface of the valve seat and the inner surface of the body.

In this aspect of the present teachings, it may be useful to crimp a portion of the body that is proximal to the orifice plate in order to form at least one protrusion. This protrusion forming step is preferably performed after the fuel injection volume per unit time is adjusted to the desired or ideal value. The protrusion will thus assist in reliably securing and positioning the valve seat/orifice plate within the body. Thus, it is not necessary to weld the valve seat or orifice plate to the body, as is known techniques.

In another aspect of the present teachings, the valve seat has at least two outer diameters. For example, the outer diameter of the valve seat that will frictionally contact the body may be greater than the outer diameter of the valve seat that is proximal to the valve seat opening. Thus, the portion of the valve seat that is proximal to (abeam of) the seal surface and opening will not contact the body when the valve seat is press-fit into the body. Because the outer surface of the valve seat that is proximal to the seal surface and opening does not frictionally contact the body, the body does not squeeze this portion of the valve seat. Thus, the possibility is reduced or eliminated that the valve seat opening, and thus the seal surface of the valve seat, will be deformed during the press-fitting operation. As a result, the integrity of the valve seat opening and the seal surface can be reliably maintained, even though the valve seat is press-fit into the body.

In the alternative, the inner diameter of the body may change relative to the valve seat. For example, the valve seat may have a constant outer diameter. In this case, the inner diameter of the body may be smaller along a portion of the inner surface that frictional contacts the valve seat than a portion of the inner surface that is proximal to (abeam of) the valve seat opening. Again, in this embodiment, the outer diameter of the valve seat that is proximal to (abeam of) the valve seat opening will not frictionally contact the inner surface of the body and the body will not exert pressure on this portion of the valve seat. As a result, deformation of the valve seat opening during the press-fitting step can be reduced or eliminated, thereby improving the reliability of the fuel injector assembly process.

Naturally, the outer diameter of the valve seat and the inner diameter of the body may both vary in order to provide a frictional fit between the valve seat and the body that is axially displaced from the position of the valve seat opening. Thus, both diameters may be varied in order to provide a fuel injector in which the portion of the valve seat that is proximal to (abeam of) the valve seat opening does not frictionally contact the body.

These aspects and features may be utilized singularly or in combination in order to make improved fuel injectors. In addition, other objects, features and advantages of the present teachings will be readily understood after reading the following detailed description together with the accompanying drawings and the claims. Of course, the additional features and aspects disclosed herein also may be utilized singularly or in combination with the above-described aspects and features.

Additional techniques for designing and manufacturing fuel injectors are disclosed in commonly assigned U.S. patent application Ser. Nos. 09/429,896 and 09/560,141 and issued U.S. Pat. Nos. 5,752,316, 5,927,613 and 5,967,419, which applications and patents are incorporated herein in their entirety.

### BRIEF EXPLANATION OF THE DRAWINGS

FIG. 1 depicts a vertical cross section of the area around the valve seat of a first representative fuel injector.

FIG. 2 depicts a vertical cross section of the area around the valve seat of a second representative fuel injector.

FIG. 3 depicts a vertical cross section of the area around the valve seat of a third representative fuel injector.

FIG. 4 depicts a vertical cross section of the area around the valve seat of a fourth representative fuel injector.

### DETAILED DESCRIPTION OF THE INVENTION

In one embodiment of the present teachings, the valve seat may be press-fitted into the interior surface of an approximately cylindrical body. The valve seat may include a seal surface proximal to an opening within the valve seat, which seal surface is adapted to contact the tip portion of the valve in order to open and close the valve seat opening.

Preferably, the outer diameter of the portion of the valve seat closest to the seal surface does not frictionally contact the interior surface of the body when the valve seat is press-fit into the body. For example, the valve seat portion that frictionally contacts the interior surface of the body may have a diameter that is greater than the outer diameter of the valve seat portion that is closest to the seal surface. In the alternative or addition thereto, the diameter of the interior surface of the body that frictionally contacts the valve seat may be less than the diameter of the inner surface of the body that is closest to the seal surface of the valve seat. That is, the valve seat portion that frictionally contacts the interior surface of the body may be axially displaced or offset from the valve seat portion disposed proximally to the valve seat opening and seal surface.

Optionally, valve seat displacement may be prevented by one or more protrusion(s) formed from the inner surface of the body and extending inwardly to contact the valve seat/orifice plate structure. In the alternative, the protrusion(s) may not contact the valve seat and/or the orifice plate, and instead may simply provide a safety feature to prevent the valve seat from significantly shifting (e.g. sliding downstream) in the event that the valve seat is axially displaced during operation.

According to this embodiment, because the valve seat portion that frictionally contacts the body and the valve seat portion that is closest to the seal surface are displaced or offset along the axial direction of the fuel injector, deformation to the seal surface during the press-fitting operation can be significantly reduced or eliminated. Further, the load applied to the valve seat when press-fitting the valve seat into the body can be increased. The protrusion, which may be optionally formed from the body, may ensure that the position of the valve seat within the body is reliably maintained. In this case, press-fitting force of the valve seat into the body can be reduced. This embodiment has the advantage of reducing manufacturing steps and costs, improving the integrity of the seal surface and securely positioning the valve seat within the body.

In another embodiment of the present teachings, the thickness of the body wall that frictionally contacts the valve seat is preferably thinner than other portions of the body.

Therefore, even if the dimensional tolerances of the body or valve seat require the axial-direction load, which is necessary to press-fit the valve seat into the body, to exceed the specified range, damage or deformation to the valve seat can be reduced or eliminated. Because the thin wall portion exerts a reduced pressure on the portion of the valve seat that frictionally contacts the body, the integrity of the seal surface can be reliably maintained during the press-fitting step.

In this embodiment, a protrusion may be formed from the material of the interior surface of the body after the fuel injection volume per unit time has been adjusted to a desired or ideal amount. This protrusion may contact an external edge of the orifice plate or may be displaced from the external edge of the orifice plate. If the degree of frictional contact between the valve seat and the body is relatively low, the protrusion preferably contacts the external edge of the orifice plate and prevents the valve seat/orifice plate from being displaced downstream when pressurized fuel or the valve is applied to the valve seat during operation. If the degree of frictional contact is relatively high and the position of the valve seat within the body will be reliably maintained when pressurized fuel or the valve is applied to the valve seat, the protrusion may be positioned downstream and thereby not contact the orifice plate. In this case, the protrusion serves as a safety device to prevent the valve seat from being displaced further than the protrusion in the event that the fuel pressure or the valve causes the valve seat to dislodge from its preferred position.

In another embodiment, the orifice plate can be welded to the valve seat along a welding ring area that encircles the opening of the valve seat. According to this structure, the valve seat itself becomes the reference for mounting the orifice plate on the valve seat. Thus, the degree of co-axiality between the valve seat and the orifice plate can be increased.

In another embodiment, the orifice plate is platter-shaped and its external edge is bent towards the upstream side in the axial direction. The external edge of the orifice plate may optionally contact the external surface of the valve seat. According to this structure, the valve seat itself becomes the reference for mounting the orifice plate on the valve seat; thus, the degree of co-axiality between the valve seat and the orifice plate can be increased.

In another embodiment, the orifice plate is platter-shaped and its external edge is bent towards the downstream side in the axial direction. Optionally, the external edge of the orifice plate may frictionally contact the interior surface of the body. According to this structure, the seal surface of the valve seat and the external edge of the orifice plate that contacts the body are axially displaced or offset. Therefore, the orifice plate can be fastened to the body without deforming the seal surface of the valve seat.

In particularly preferred embodiments of the present teachings, electromagnetic fuel injector may have a body, a valve, a valve seat and an orifice plate. The body and valve seat may be generally cylindrical, although other shapes and cross-sections may be utilized. The valve preferably reciprocates inside the body. The valve seat may be positioned within the interior surface of the body such that an opening in the valve seat closes when the valve is moved downstream to a closed position and the opening opens when the valve is moved upstream away from the closed position. The orifice plate preferably contacts the valve seat on the side opposite of the valve.

Such fuel injectors may be manufactured by press fitting the valve seat into the interior surface of the body. The fuel output rate may be adjusted while press fitting the valve seat into the body. Preferably, after the valve seat is press-fit and appropriately positioned within the body, an inward protrusion is formed from the interior surface, which inward protrusion is adapted to prevent the orifice plate from moving past the protrusion. Herein, the term “protrusion” refers to a portion of the body in which the metal projects inwardly from the interior surface of the body. This protrusion may be formed, for example, by crimping the interior surface of the body, although other techniques may be utilized to form the protrusion.

As discussed above, if a very tight frictional fit between the valve seat and the body is desired, a large press-fitting force may be required to fix the valve seat within the body. In this case, the inner surface of the body will press against the outer diameter of the valve seat and may cause the outer diameter of the valve seat to be reduced. As a result of such reduction in diameter, the valve seat and the valve seat opening may be warped or deformed, thereby changing the shape of the valve seal surface. If the integrity of the valve seat surface is disturbed the valve and the valve seat will not tightly contact each other around the entire seal surface, thereby leaving gaps in the seal when the valve is in the closed position. Consequently, fuel may leak through the valve seat even when the valve is in the closed position.

In order to overcome this problem, the present teachings provide a protrusion formed on the interior surface of the body that prevents the valve seat from axially displacing or sliding downstream during operation. If this protrusion is utilized, the press-fitting load applied to the valve seat can be reduced and deformation of the valve seat caused by the press-fitting load can be reduced. Therefore, the seal surface does not change during the press fitting step and a tight seal between the valve and the valve seat can be ensured when the valve is in the closed position.

In one representative method for manufacturing a fuel injection valve, the relative positions of the valve seat and the body may be first determined during the press-fitting step. These relative positions are set in order to obtain a desired or ideal fuel injection amount per unit time for the fuel injector. After the desired value has been set, a protrusion may be formed on the interior surface of the body. Preferably, the protrusion is integral with the body and is formed of the same material as the body in order to provide a reliable stopping point. For example, the protrusion may be formed by crimping the interior surface of the body after the position of the valve seat within the body has been set. The protrusion may preferably contact a portion of the orifice plate, although the protrusion is not required to contact the orifice plate.

Because the relative positional relationship between the valve seat and the body is appropriately adjusted during the press-fitting step in order to set the fuel output rate, the subsequent protrusion formation step merely maintains the relative positions of the valve seat and the body set during the press fitting process. Thus, the relative positions of the valve seat and the body will not change after the fuel injection volume per unit time has been tuned to the desired or ideal amount. Further, the protrusion will not “spring-back,” which might ordinarily be caused by plastic deformation and affect the relative positional relationship between the valve seat and the body. That is, the relative positional relationship between the two components can be fixed by means of the press-fitting process. Therefore, by press-fitting the valve seat into the body while measuring the fuel injection volume per unit time and stopping the press-fitting when the desired fuel injection volume per unit time is reached, fuel injection valves can be easily and reliably manufactured that have desired or ideal flow rate characteristics. No further steps are required to re-adjust the fuel output rate, thereby reducing labor costs to assemble the fuel injector.

By press-fitting the valve seat into the body as well as forming a protrusion to prevent the orifice plate from being axially displaced, such fuel injection valves may reliably maintain the position of the valve seat within the body. Therefore, the press-fitting load applied to the valve seat may be within a range that does not deform the valve seat, which will prevent fuel leakage when the valve is in the closed position.

Furthermore, it is possible to manufacture a fuel injection valve in which the fuel injection volume per unit time is tuned to the desired value by means of a simple process in which press-fitting is performed while simultaneously measuring the fuel injection volume per unit time. The press-fitting step is stopped when the desired fuel injection volume per unit time is reached. Thus, according to the present teachings, it is only necessary to tune the desired fuel injection volume per unit time once, which is a significant improvement over known techniques that require the fuel injection amount per unit time to be adjusted at least twice and sometimes many times.

Each of the additional features and method steps disclosed above and below may be utilized separately or in conjunction with other features and method steps to provide improved fuel injectors and methods for making and using the same. Representative examples of the present teachings, which examples will be described below, utilize many of these additional features and method steps in conjunction. However, this detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the present teachings in the broadest sense, and are instead taught merely to particularly describe representative and preferred embodiments of the present teachings, which will be explained below in further detail with reference to the figures. Of course, features and steps described in this specification may be combined in ways that are not specifically enumerated in order to obtain other usual and novel embodiments of the present teachings.

First Representative Embodiment

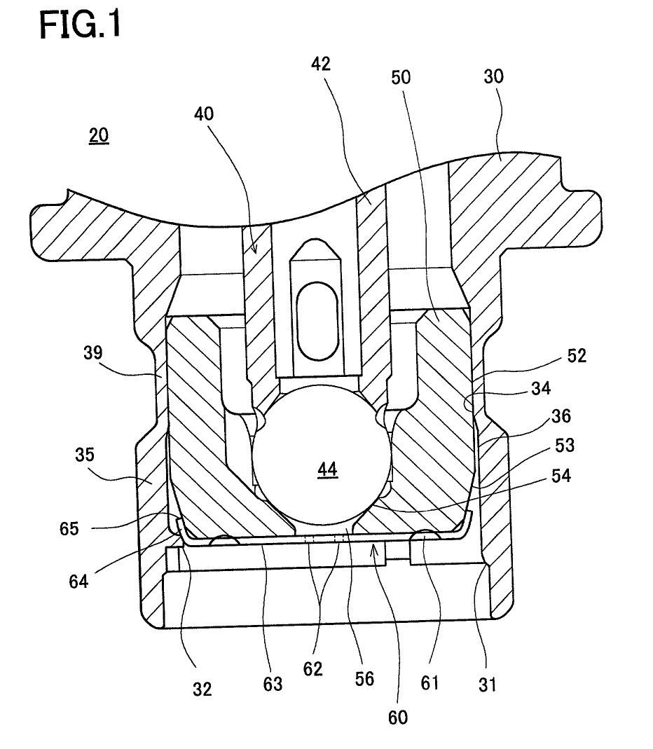

FIG. 1 shows a vertical cross section of the portion of the fuel injector 20 having valve seat 50 and body 30, both of which optionally may be approximately cylindrical. Valve 40 is reciprocally disposed within body 30 and includes cylinder 42 and ball 44 that is fastened to the tip of cylinder 42. Valve 40 is downwardly biased by a spring (not shown). When a solenoid coil (not shown) is energized, the magnetic field causes valve 40 to move upwardly as shown in FIG. 1.

Valve seat 50 frictionally contacts body 30 along the portion of the body that is proximal to the connection of cylinder 42 to ball 44. Valve seat 50 has an opening 56, which closes when valve 40 moves downstream (i.e. downwardly in FIG. 1) and opens when valve 40 moves upstream (i.e. upwardly in FIG. 1). An orifice plate 60 is preferably welded to the downstream side of valve seat 50 along a ring-shaped weld 61 that encircles opening 56 and orifice plate 60 caps valve seat 50 and valve seat opening 56. Fuel injection holes 62 are formed in the center portion of orifice plate 60 in order to permit fuel to be exhausted from the fuel injector 20.

Orifice plate 60 may be cup-shaped and terminating edge 65 of its exterior surface 64 may be bent upstream. Because valve seat 50 is a reference for attaching orifice plate 60 to valve seat 50, co-axiality between valve seat 50 and orifice plate 60 is guaranteed. Orifice plate 60 may be a relatively thin plate, or may be relatively a thick plate. That is, the thickness of orifice plate 60 and the number, diameter and design of fuel injection holes 62 may be freely selected to suit the particular spraying characteristics that are required for a commercial embodiment.

Valve seat 50 is press-fit into the interior surface of body 30 and thus at least a portion of valve seat 50 frictionally contacts the interior surface of body 30. Orifice plate 60 may be prevented from moving or sliding downstream by the protrusion 32 formed on the interior surface of body 30. In the first representative embodiment, the upper portion of valve seat 50 has a relatively large-diameter portion 52 that frictionally contacts body 30. The lower portion of valve seat 50 also has a relatively small-diameter portion 53 that does not frictionally contact body 30. Preferably, the diameter of relatively large-diameter area 52 before press-fitting is slightly greater than the diameter of the interior surface of body 30. In this case, valve seat 50 is reliably secured within body 30 by press-fitting valve seat 50 into body 30, because the large-diameter portion 52 presses against the smaller diameter of the interior surface of body 30.

In this representative embodiment, three protrusions 32 (only one protrusion 32 is shown in FIG. 1 for the purposes of clarify) are formed in three locations on the interior surface of body 30 and are preferably evenly spaced around the perimeter. Three punches (i.e. rod-shaped tools) may be pressed against step 31, which is pre-formed on body 30, to thereby form three protrusions 32. Naturally, greater or fewer protrusions 32 may be utilized. In fact, as few as one protrusion 32 may be utilized. Also, the protrusions 32 are not required to be evenly spaced around the perimeter of step 31.

The fuel injection volume per unit time is greatly affected by the gap between valve 40 and valve seat 50 when the valve 40 is open. A relatively wide gap increases the fuel injection volume per unit time and a relatively narrow gap decreases the fuel injection volume per unit time, if all other conditions are equal. The volume of fuel supplied to the engine is basically controlled by the amount of time during which the electromagnetic fuel injector stays open. Therefore, in order to accurately tune the volume of fuel to be supplied to the engine, the fuel injection volume per unit time while the valve is open must be accurately tuned to the desired value. Consequently, accurate tuning of the positional relationship of valve seat 50 relative to body 30 in the axial direction is extremely important.

According to known techniques, the appropriate gap between valve 40 and valve seat 50 when the valve is open was ensured to fall within a certain range when the electromagnetic fuel injector is assembled, by precisely controlling the dimensions of the individual components. However, in order to obtain the desired gap by accurately controlling the dimensions of individual components, it is necessary to manufacture the individual components with an accuracy of several microns. Thus, the requirement to use high tolerance components naturally increased manufacturing costs in known fuel injectors.

On the other hand, the present fuel injectors do not require components with high dimensional accuracy, because the valve stroke/gap is accurately tuned when assembling the components. That is, the accuracy of the fuel injection volume per unit time obtained by the present tuning techniques is not particularly dependent upon the tolerance of the individual components. Further, because it is not necessary to weld the valve seat/orifice plate to the body after the press-fitting step, it is not necessary to re-adjust the fuel output rate. By providing techniques that permit the use of lower tolerance parts, manufacturing costs can be reduced without reducing the accuracy of the fuel injection volume per unit time or the reliability of the fuel injector. Thus, the present techniques provide a significant advantage over known fuel injector manufacturing techniques for at least this reason.

In one representative method for tuning the gap between valve 40 and valve seat 50, orifice plate 60 is first welded to valve seat 50 and is then inserted into body 30 to a temporary position. After the preliminary insertion, valve seat 50 is press-fitted more deeply into body 30 while simultaneously measuring the fuel injection volume per unit time. As the press-fitting depth increases, the fuel injection volume per unit time decreases. The press-fitting step is stopped when the desired fuel injection volume per unit time is reached.

After the press-fitting step is completed, three punches (not shown) are inserted into body 30 from below. The tips of the three punches contact step 31 on the interior surface of body 30. When the punches are raised further, step 31 deforms and metal rises around the tips of the punches. In this embodiment, protrusions 32, which are formed using this technique, will contact orifice plate 60 and will prevent orifice plate 60 from being displaced downstream.

Because the crimping process is stopped when protrusions 32 contact orifice plate 60, orifice plate 60, and consequently valve seat 50, do not become displaced relative to body 30 during the protrusion forming step, and the fuel injection volume per unit time tuned during press-fitting is not changed by the crimping process. Persons skilled in the art will recognize that it is possible to perform the press-fitting step and the crimping step either simultaneously or sequentially.

When valve seat 50 is press-fitted into body 30 using a large load, the diameter of valve seat 50 may shrink and thereby deform seal surface 54. Although the diameter of valve seat 50 is designed to uniformly shrink during the press-fitting step, the exterior perimeter of valve seat 50 is typically not a true circle. Thus, if the outer diameter of valve seat 50 is not a perfect circle, it may not shrink uniformly when press-fitted into the cylindrical body 30. However, a high degree of true circularity is required for seal surface 54, because the contact of ball 44 and seal surface 54 closes the fuel passage. Thus, even a slightly non-uniform deformation of seal surface 54 will cause fuel leakage when the valve is in the closed position.

The three following techniques may be optionally utilized, either singularly or in combination, to prevent or significantly reduce deformation of seal surface 54 when valve seat 50 is press fit into body 30.

First, as noted above, one or more protrusions 32 may be utilized in fuel injector 20 to prevent valve seat 50 and orifice plate 60 from being displaced toward the downstream tip of body 30 during operation. Because the protrusion(s) 32 also serve(s) to securely fix the position of the valve seat 50 within body 30, the degree of frictional contact between valve seat 50 and body 30 may be reduced. For example, the outer diameter of valve seat 50 is only required to be slightly larger than the inner diameter of body 30 along the portions of the valve seat 50 and body 30 that frictionally contact each other. As a result, the press-fitting force to insert valve seat 50 into body 30 can be reduced, as compared to known fuel injector manufacturing techniques. Further, as compared to techniques in which valve seat 50 is securely fastened to body 30 using only frictional contact between valve seat 50 and body 30, the integrity of seal surface 54 can be maintained during the press fitting step and a tight seal is possible when the valve is in the closed position. In the first embodiment, both the protrusions 32 and frictional contact cooperate to prevent the displacement of the vale seat 50, so that the press-fitting force may be reduced. Therefore, the frictional contact portion 52 of the valve seat 50 may be provided at lower portion of the valve seat, which surrounds the seal surface 54.

Second, as shown in FIG. 1, body 30 may include a thin wall portion 39 along the portion 34 of body 30 that will frictionally contact valve seat 50. Preferably, thin wall portion 39 is thinner than the other portions 35 of body 30. According to this technique, even if the dimensional tolerances of particular components causes the press-fitting margin to become unexpectedly large, the force applied by thin wall portion 39 against upper portion 52 of valve seat 50 is reduced. Thus, deformation to seal surface 54 can be prevented or significantly reduced. In the first embodiment, the third feature which is described latter is adopted, so that the press-fitting force may be increased. Therefore, the wall portion 39 may be omitted.

Third, as shown in FIG. 1, lower portion 53 of valve seat 50 does not frictionally contact a lower portion 36 of the interior surface of body 30, because the frictional contact portion 52 of valve seat 50 is axially displaced or offset from the lower portion 53 of valve seat 50. Lower portion 53 corresponds to the outer surface of valve seat 50 that is closest to opening 56 and seal surface 54. Consequently, force is exerted on upper portion 52, because the outer diameter of upper portion 52 is larger than the inner diameter of a portion 34 of body 30 before the press fitting step. Thus, the upper portion 52 frictionally contacts body 30 at portion 34 and securely positions valve seat 50 within body 30. However, because lower portion 53 does not frictionally contact body 30 at portion 36, due to the fact that the outer diameter of lower portion 53 is less than the inner diameter of body 30 at portion 36, no force, or only a reduced force, is applied to lower portion 53. Thus, no force, or only a reduced force, is applied in the vicinity of seal surface 54, which force may non-uniformly deform seal surface 54. In this case, a large pressing force may be applied to the valve seat so that the valve seat tightly fits within the body and displacement of the valve seat relative to the body is effectively prevented by this tight fitting. Therefore protrusions 32 and thin wall portion 39 may be omitted.

As noted above, the three above-mentioned techniques may be utilized singularly or in combination in order to make improved fuel injectors. The embodiment shown in FIG. 1 utilizes all three features for safety reason, however, one or two features may be omitted.

According to the present techniques, the fuel output rate is precisely tuned during the press-fitting process. Further, the process of forming protrusions 32, which may be subsequently executed, will not change the fuel output rate. Instead, protrusion(s) 32 will maintain the desired or ideal fuel flow rate characteristics and thus, it is not necessary to re-tune the stroke (gap) after forming protrusions 32. Naturally, protrusion(s) 32 also serve(s) to prevent valve seat 50 exiting the fuel injector 20, in the event that valve seat 50 becomes dislodged from body 30 for any reason.

Second Representative Embodiment

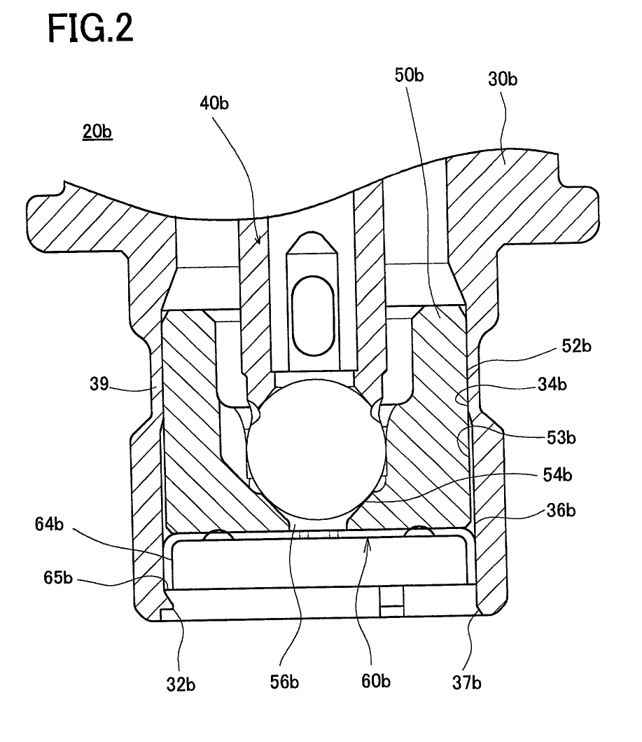

FIG. 2 shows a vertical cross section of the area around the valve seat of the second representative fuel injector, which may have an approximately cylindrical body 30b and a valve 40b that reciprocates within body 30b. A valve seat 50b may be positioned on the tip side of valve 40b and have an opening 56b. The valve seat 50b may frictionally contact body 30b in a positional relationship such that opening 56b becomes closed when valve 40b moves forward and opening 56b becomes open when valve 40b moves backward. An orifice plate 60b may be welded, preferably laser welded, to valve seat 50b on the downstream side of valve seat 50b.

A portion 52b of the outer surface of valve seat 50b may frictionally contact a portion 34b of the inner surface of body 30b. Preferably, the lower portion 53b of valve seat 50 does not frictionally contact the lower portion 36b of the inner surface of body 30b in order to prevent deformation of seal surface 54b during the press-fitting step, as was discussed in further detail above. Thus, the upper portion 52b of valve seat 50b that frictionally contacts body 30b is axially offset or displaced from the portion 53b of valve seat 50b that is closest or proximal to seal surface 54b. In this embodiment, the outer diameter of valve seat 50b is substantially constant and the inner diameter of body 30b increases along the axial direction. That is, the diameter of portion 36b is larger than the diameter of portion 34b. Thus, this embodiment also achieves the object of preventing, or significantly reducing, deformation of seal surface 54b during the press-fitting step, while still providing a secure frictional contact between portion 52b of valve seat 50b and portion 34b of the inner surface of body 30b.

In addition, at least one protrusion 32b also may be optionally utilized in the second representative embodiment, which protrusion 32b may contact the external edge 64b of orifice plate 60b. Thus, protrusion 32b may preferably extend from the interior surface of body 30b on the downstream side of orifice plate 60b. The terminating edge 65b of external edge 64b of orifice plate 60b may extend downstream, i.e., toward protrusion 32b. Further, the external diameter of external edge 64b of orifice plate 60b before press-fitting is preferably slightly larger than the diameter of the interior surface of body 30b. Thus, external edge 64b of orifice plate 60b may frictionally contact the inner surface of body 30b.

In this second representative fuel injector 20b, valve seat 50b frictionally contacts body 30b at two locations, i.e., at the upstream side 52b of valve seat 50b and at external edge 64b of orifice plate 60b. The load for press-fitting external edge 64b of orifice plate 60b is significantly less than the load for press-fitting the upstream side 52b of valve seat 50b. Because external edge 64b of orifice plate 60b is press-fitted in a position that is offset from seal surface 54b along the axial direction, the load for press-fitting external edge 64b of orifice plate 60b does not influence seal surface 54b.

In fuel injector 20b shown in FIG. 2, protrusion 32b may be formed by pressing the downstream edge 37b of body 30b using a punch (not shown). However, because protrusion 32b is not intended to apply pressure on orifice plate 60b, a gap may be provided between protrusion 32b and orifice plate 60b. Protrusion 32b prevents valve seat 50b from falling out, if valve 50b dislodges from body 30b during operation. In this fuel injector 20b, press fitting is performed at position 52b, which is offset in the axial direction from seal surface 54b. Therefore, even when a relatively large load is used to press-fit valve seat 50b into body 30b, the press-fitting load rarely deforms seal surface 54b. Because the use of a relatively large press-fitting load, and thus a relatively tight frictional contact between valve seat 50b and body 30b, can prevent the fuel injection volume per unit time from varying over time, orifice plate 60b is not required to be retained by protrusion 32b.

In the embodiment shown in FIG. 2, not only the upstream side 52b of the valve seat 50b but also the external edge 64b of the orifice plate 60b are press fit within the body 30b, so the pressing force for inserting the valve seat 50b can be reduced. A thin wall 39 is provided for preventing excessive force applied to the valve seat 50b. The lower portion 53b may contact the body 30b, because the press fitting force is reduced.

Third Representative Embodiment

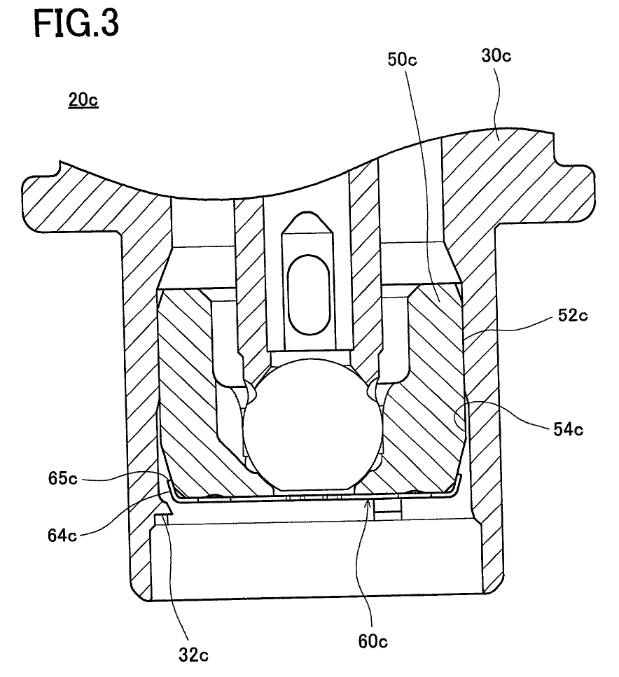

FIG. 3 shows a vertical cross section of the area around the valve seat of a third representative fuel injector. The third representative embodiment primarily relies upon the frictional contact between valve seat 50c and body 30c to prevent the desired or ideal fuel injection volume per unit time from varying over time. Thus, protrusion 32c is merely intended to prevent valve seat 50c from falling out, in the event that valve seat 50c dislodges during operation. As shown in FIG. 3, fuel injector 20c is assembled such that the terminating edge 65c of the external edge 64c of orifice plate 60c is orientated upstream and orifice plate 60c caps valve seat 50c.

A gap is provided between the external edge 64c of orifice plate 60c and protrusion 32c formed on body 30c. Further, external edge 64c of orifice plate 60c also does not contact the interior surface of body 30c. Therefore, only the upstream side 52c of valve seat 50c frictionally contacts body 30c.

When terminating edge 65c of external edge 64c of orifice plate 60c is oriented such that it caps valve seat 50c, valve seat 50c itself acts as the assembly reference, thus providing the benefit of increasing the degree of co-axiality between orifice plate 60c and valve seat 50c.

Because this embodiment relies upon frictional contact between valve seat 50c and body 30c to maintain the desire position of valve seat 50c within body 30c, a thin wall portion of body 30c is not provided in this embodiment. However, a thin wall portion can be provided, if desired. In this embodiment, offsetting the press fitting portion 52c from the lower portion 54c of the valve seat 50c in the axial direction is essential.

Fourth Representative Embodiment

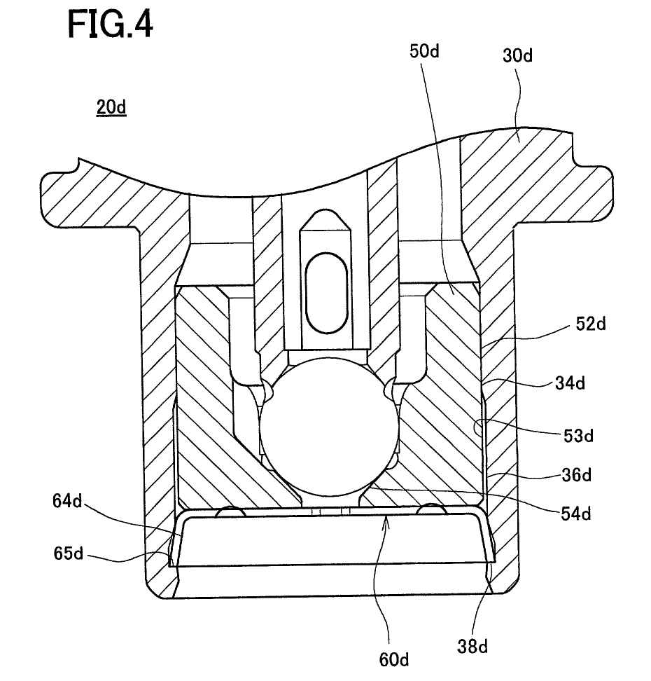

FIG. 4 shows a vertical cross section of the area around the valve seat of the fourth representative fuel injector 20d, in which the terminating edge 65d of the external edge 64d of orifice plate 60d is orientated downstream. In this structure, two frictional contact points are provided, i.e., at the upstream side 52d of valve seat 50d and at the external edge 64d of orifice plate 60d.

In the fourth representative embodiment, deformation of seal surface 54d is prevented, or significantly reduced, because valve seat 50d frictionally contacts body 30d only along portion 52d. Portion 53d of valve seat 50c does not frictionally contact portion 36d of the inner surface of body 30d. Thus, no force, or only a significantly reduced force, is applied to seal surface 54d during the press fitting step, as discussed in further detail above.

The fuel injector 20d shown in FIG. 4 is similar to electromagnetic fuel injector 20c shown in FIG. 3, because fuel injector 20d relies primarily upon the frictional contact between portion 34d and portion 52d to prevent the fuel injection volume per unit time from varying over time. However, in this representative embodiment, a step 38d is formed with body 30d, which step will prevent valve seat 60d from falling out. No protrusions are provided in this embodiment.

Step 38d may be formed, for example, when body 30d is manufactured. Thereafter, orifice plate 60d and valve 50d, which have been previously welded together, are press fit into body 30d. If orifice plate 60d is resiliently elastic, external edge 64d of orifice plate 60d may snap-fit past and over step 38d. Thereafter, terminating edge 65d may contact step 38d and step 38d may prevent valve seat 50d from falling out of body 30d during operation. Optionally, step 38d may be fastened to terminating edge 65d by welding or another fastening process.

According to the fourth representative embodiment, step 38d can be provided during the manufacture of body 30d and thus eliminate the need for a crimping or other protrusion forming step after the valve seat 50d has been press fit into body 30d.

Although the detailed representative embodiments have been described in terms of a fuel injector for an internal combustion engine, the present teachings can be applied to valves for metering the flow of any type of fluid.

1. A fuel injector comprising:
a body having a hollow interior portion,
a valve reciprocally disposed within the hollow interior portion of the body,
a valve seat disposed within the hollow interior portion of the body, the valve seat having an opening, wherein the valve seat is positioned within the body such that the opening is closed when the valve is in a closed position and the opening permits fluid to pass through the opening when the valve is not in the closed position,
wherein at least a portion of the valve seat frictionally contacts the body, an orifice plate fastened to the valve seat, the orifice plate having at least one hole adapted to permit fluid to pass through the hole, and
at least one protrusion extending substantially inwardly from the body and positioned downstream of the orifice plate.

2. A fuel injector as in claim 1, wherein the valve seat comprises at least a first exterior surface portion and a second exterior surface portion, wherein the first exterior surface portion and the second exterior surface portion are offset along an axial direction of the valve seat, the second exterior portion is closest to the valve seat opening, the first exterior surface portion frictionally contacts the body and the second exterior surface portion does not frictionally contact the body.

3. A fuel injector as in claim 1, wherein the body further comprises a relatively thin wall portion that frictionally contacts at least a portion of the valve seat.

4. A fuel injector as in claim 1, wherein the orifice plate is ring welded to the valve seat and the ring weld completely encircles the valve seat opening.

5. A fuel injector as in claim 1, wherein the orifice plate is platter-shaped and an external edge of the orifice plate is bent to the upstream side in the axial direction, wherein the external edge contacts the valve seat.

6. A fuel injector as in claim 1, wherein the orifice plate is platter-shaped and an external edge of the orifice plate is bent to the downstream side in the axial direction, and the external edge frictionally contacts the body.

7. A fuel injector as in claim 1, wherein the at least one protrusion contacts the orifice plate.

8. A fuel injector as in claim 7, wherein the valve seat comprises at least a first exterior surface portion and a second exterior surface portion, wherein the first exterior surface portion and the second exterior surface portion are offset along an axial direction of the valve seat, the second exterior portion is closest to the valve seat opening, the first exterior surface portion frictionally contacts the body and the second exterior surface portion does not frictionally contact the body and the body further comprises a relatively thin wall portion that frictionally contacts the first exterior surface portion of the valve seat.

9. A fuel injector comprising:
a body having a hollow interior portion,
a valve reciprocally disposed within the hollow interior portion of the body,
a valve seat disposed within the hollow interior portion of the body, the valve seat having an opening, wherein the valve seat is positioned within the body such that the opening is closed when the valve is in a closed position and the opening permits fluid to pass through the opening when the valve is not in the closed position, wherein a first portion of the outer surface of the valve seat frictionally contacts the body and a second portion of the outer surface of the valve seat does not frictionally contact the body, the first and second portion being offset along the axial direction of the valve seat and the second portion is closest to the valve seat opening and
an orifice plate fastened to the valve seat, the orifice plate having at least one hole adapted to permit fluid to pass through the hole.

10. A fuel injector as in claim 9, further comprising at least one protrusion extending substantially inwardly from the body and positioned downstream of the orifice plate.

11. A fuel injector as in claim 10, wherein the at least one protrusion contacts the orifice plate.

12. A fuel injector as in claim 9, wherein the orifice plate is welded to the valve seat by a ring weld that completely encircles the valve seat opening.

13. A fuel injector as in claim 9, wherein the orifice plate is platter-shaped and an external edge of the orifice plate is bent to the upstream side in the axial direction, wherein the external edge contacts the valve seat.

14. A fuel injector as in claim 9, wherein the orifice plate is platter-shaped and an external edge of the orifice plate is bent to the downstream side in the axial direction, and the external edge frictionally contacts the body.

15. A fuel injector as in claim 9, wherein the body further comprises a relatively thin wall portion that frictionally contacts at least a portion of the valve seat.

15. A method of manufacturing a fuel injector comprising:
inserting a valve seat into a fuel injector body while simultaneously measuring fluid volume per unit time passing through the fuel injector, wherein at least a portion of the valve seat frictionally contacts the inner surface of the fuel injector body and the valve seat has an opening adapted to permit fluid to pass through the opening, wherein an orifice plate is fastened to the valve seat and comprises at least one hole adapted to permit fluid to pass through the hole,
stopping the insertion when the desired fluid volume per unit time is achieved, and
forming at least one protrusion from the inner surface of the fuel injector body downstream of the valve seat.

17. A method as in claim 16, further comprising forming the protrusion so that the protrusion contacts the orifice plate.

18. A method as in claim 17, wherein an outer circumference of a portion of the valve seat closest to the valve seat opening is less than an inner circumference of the fuel injector body before the valve seat is inserted into the fuel injector body.

19. A method as in claim 16, wherein an outer circumference of a portion of the valve seat closest to the valve seat opening is less than an inner circumference of the fuel injector body before the valve seat is inserted into the fuel injector body.

20. A method as in claim 16, further comprising welding the orifice plate to the valve seat before inserting the valve seat into the fuel injector body, wherein the weld completely encircles the valve seat opening.
